(19) United States
(12) Patent Application Publication
(10) Pub. No.: US 2017/0293135 A1
(43) Pub. Date: Oct. 12, 2017

(54) EYEPIECE STRUCTURE FOR SURGICAL MICROSCOPE

(71) Applicant: MITAKA KOHKI CO., LTD., Tokyo (JP)

(72) Inventors: Shuji INABA, Tokyo (JP); Katsuyuki NAKAMURA, Tokyo (JP); Masao DOI, Tokyo (JP); Kenji OHATA, Osaka (JP)

(73) Assignee: MITAKA KOHKI CO., LTD., Tokyo (JP)

(21) Appl. No.: 15/468,840

(22) Filed: Mar. 24, 2017

(30) Foreign Application Priority Data
Apr. 11, 2016 (JP) 2016-078646

(51) Int. Cl. G02B 25/00; G02B 7/04; G02B 21/00

(52) U.S. Cl. CPC G02B 25/001; G02B 21/0012; G02B 7/04

(57) ABSTRACT

An eyepiece structure for a surgical microscope includes an inner barrel, an intermediate barrel, and outer barrels. When the outer barrels are rotated, a protrusion of the inner barrel is guided along a spiral groove of the outer barrel and is moved back and forth along an optical axis. The protrusion is guided through a straight hole of the intermediate barrel that is not rotatable, and therefore, the inner barrel moves along the optical axis without rotating around the optical axis. An astigmatic lens is added to the inner barrel that is nonrotatable, to enable a surgeon suffering from astigmatism to conduct a surgical operation without glasses.

### BACKGROUND OF THE INVENTION

### 1. Field of the Invention

The present invention relates to an eyepiece structure for a surgical microscope.

### 2. Description of Related Art

A surgical microscope is provided with a left-and-right pair of eyepieces to three-dimensionally observe a surgical site. The eyepieces incorporate a vision correction lens as optics for adjusting diopter scale according to the eyesight of an individual observer.

The vision correction lens is fixed to an inner barrel of each eyepiece and is configured to rotate and move together with the inner barrel when an outer barrel of the eyepiece is rotated. A related art is, for example, Japanese Unexamined Patent Application Publication No. 2010-49111.

The vision correction lens in each eyepiece has no directivity with respect to rotation directions, and therefore, the related art may cause no problem when adjusting the vision correction lens by rotating the same together with the inner barrel. However, the related art never allows a correction lens to be added to the vision correction lens attached to the inner barrel if the correction lens has directivity with respect to rotation directions. For example, a surgeon who suffers from astigmatism may want to add an astigmatic lens to the inner barrel so that the surgeon may remove his or her glasses during operation. The astigmatic lens has a prescribed orientation, and therefore, will lose its function if it is rotated. Due to this, the related art is unable to add the astigmatic lens to the inner barrel.

There is another need for a side projection to be formed on a rubber attached to an end of the inner barrel of each eyepiece, so that the side projection protrudes rightward (or leftward) to prevent external light from laterally entering into the eyepiece. The side projection has a fixed orientation, and therefore, the related art never allows the same to be attached to the inner barrel that rotates.

### SUMMARY OF THE INVENTION

The present invention provides an eyepiece structure for a surgical microscope, capable of being nonrotatable around an optical axis when an inner barrel is moved along the optical axis to adjust diopter scale.

According to a first aspect of the present invention, the eyepiece structure for a surgical microscope has an inner barrel that incorporates a vision correction lens and an outer barrel that is rotated. The eyepiece structure includes an intermediate barrel that is interposed between the outer barrel and the inner barrel, is not rotatable, and has a straight hole, a spiral groove formed on an inner face of the outer barrel, and a protrusion that is formed on an outer face of the inner barrel and is engaged through the straight hole with the spiral groove.

### BRIEF DESCRIPTION OF THE DRAWINGS

FIG. 1 is a perspective view illustrating a surgical microscope having an eyepiece structure according to an embodiment of the present invention;

FIG. 2 is a perspective view illustrating the surgical microscope with an eyepiece optical unit thereof being separated;

FIG. 3 is a side view illustrating the surgical microscope;

FIG. 4 is a perspective view illustrating an eyepiece employing the eyepiece structure according to the embodiment of the present invention;

FIG. 5 is a sectional view illustrating the eyepiece;

FIG. 6 is a sectional view illustrating the eyepiece with an outer barrel thereof to be rotated;

FIG. 7 is an exploded perspective view illustrating the eyepiece;

FIG. 8 is an exploded sectional view illustrating the eyepiece;

FIG. 9 is a plan view illustrating the eyepiece;

FIG. 10 is a front view illustrating a side projection of the eyepiece; and

FIG. 11 is a side view illustrating the eyepiece covered with a drape.

### DESCRIPTION OF PREFERRED EMBODIMENTS

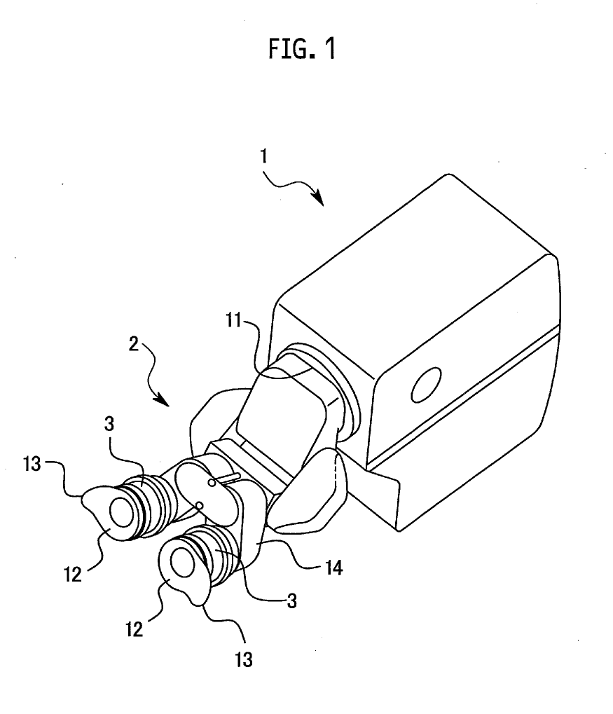

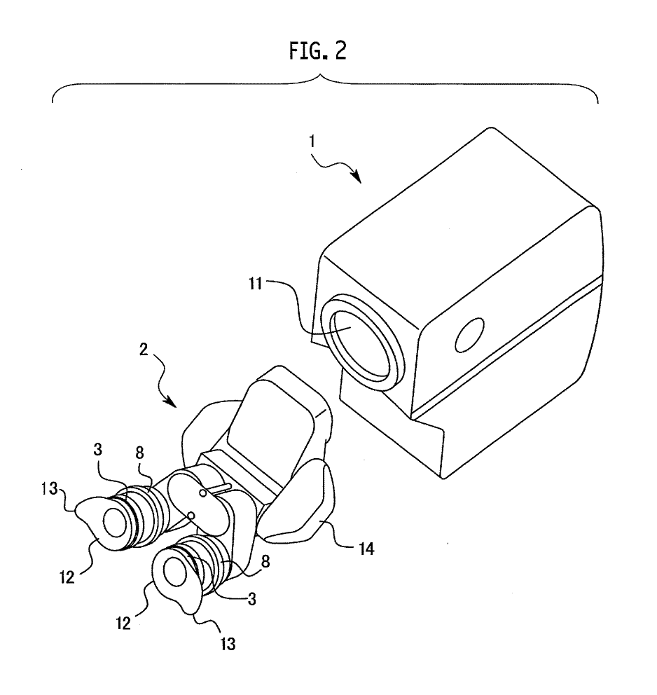

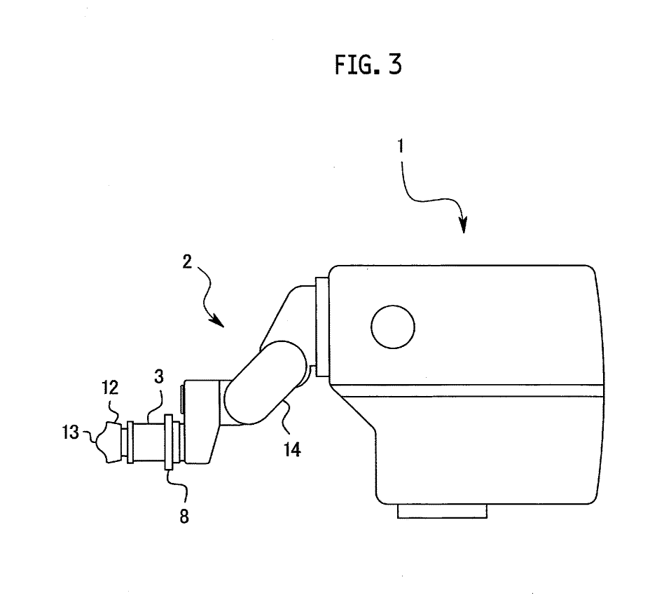

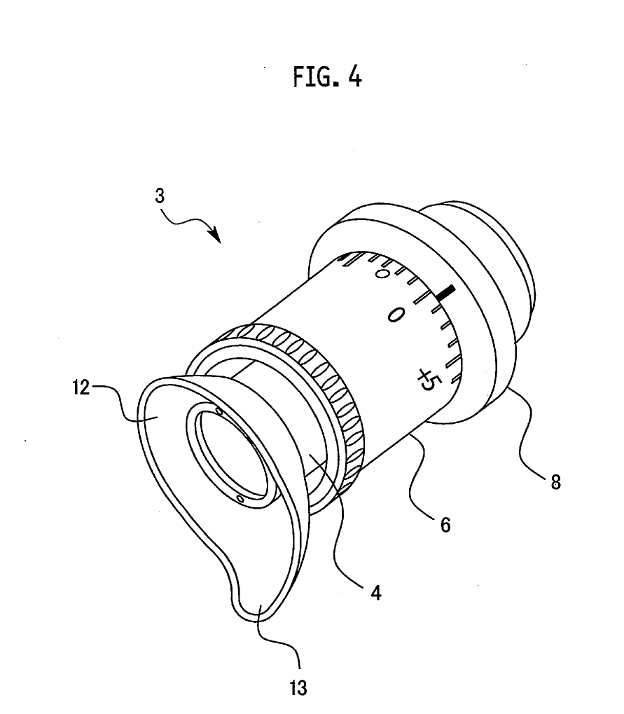

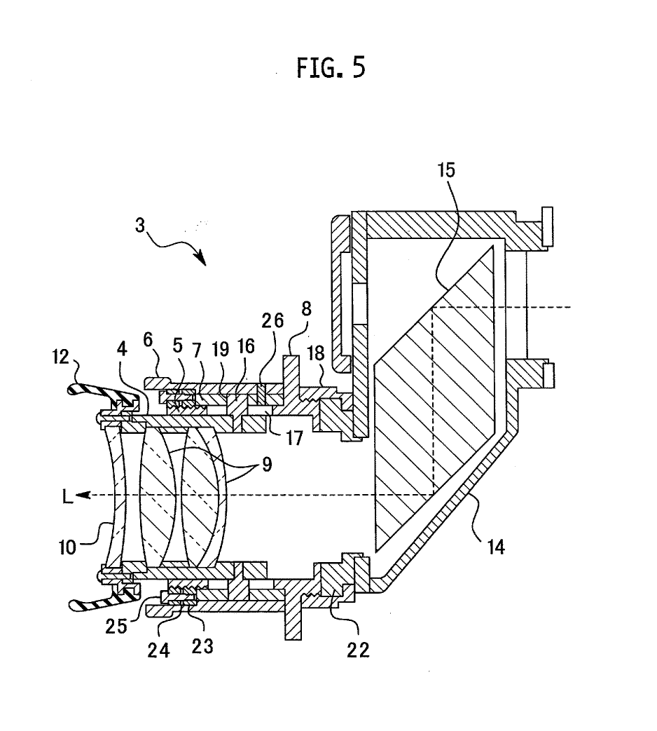

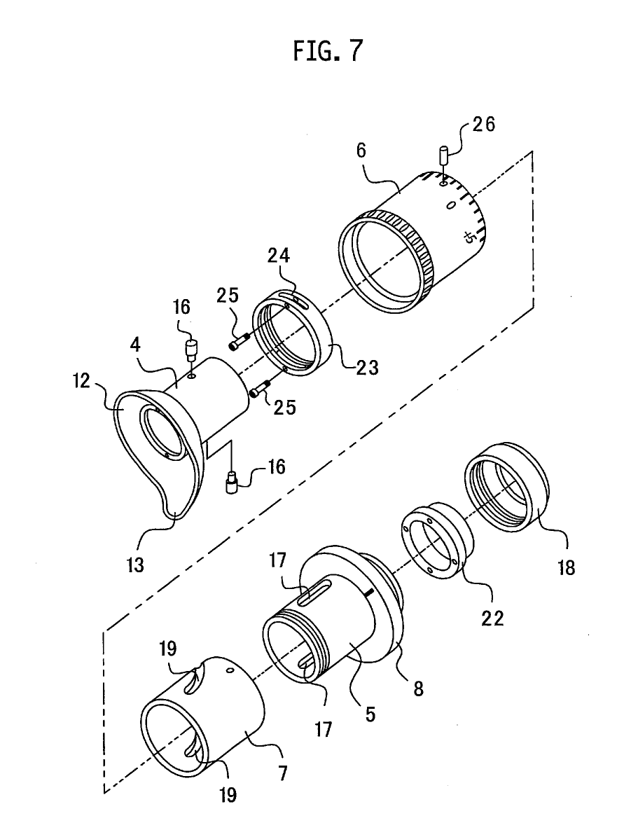

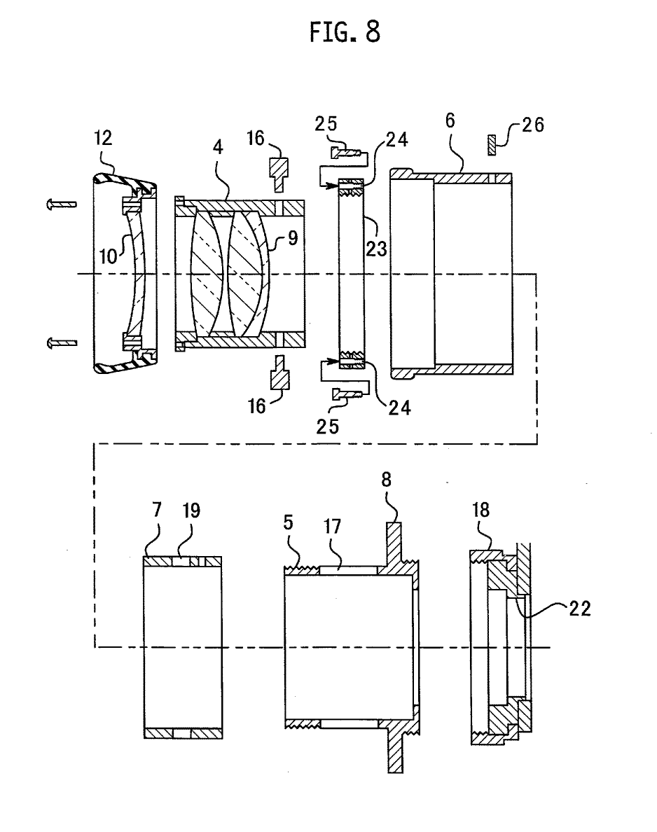

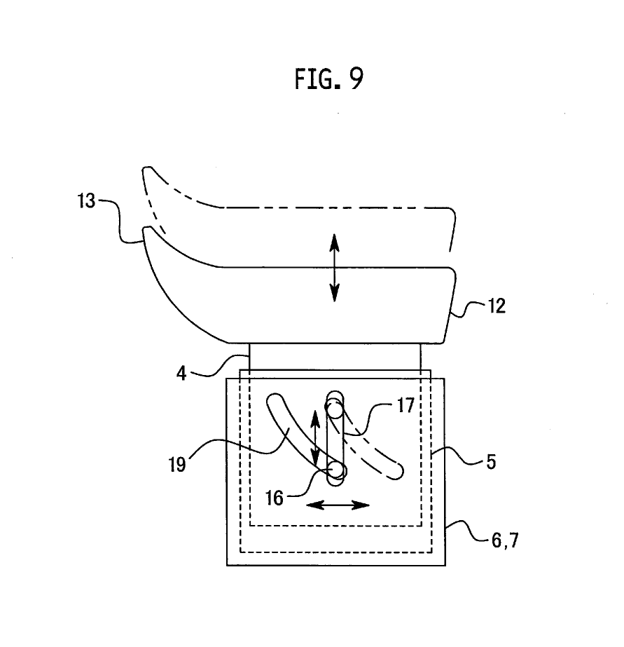

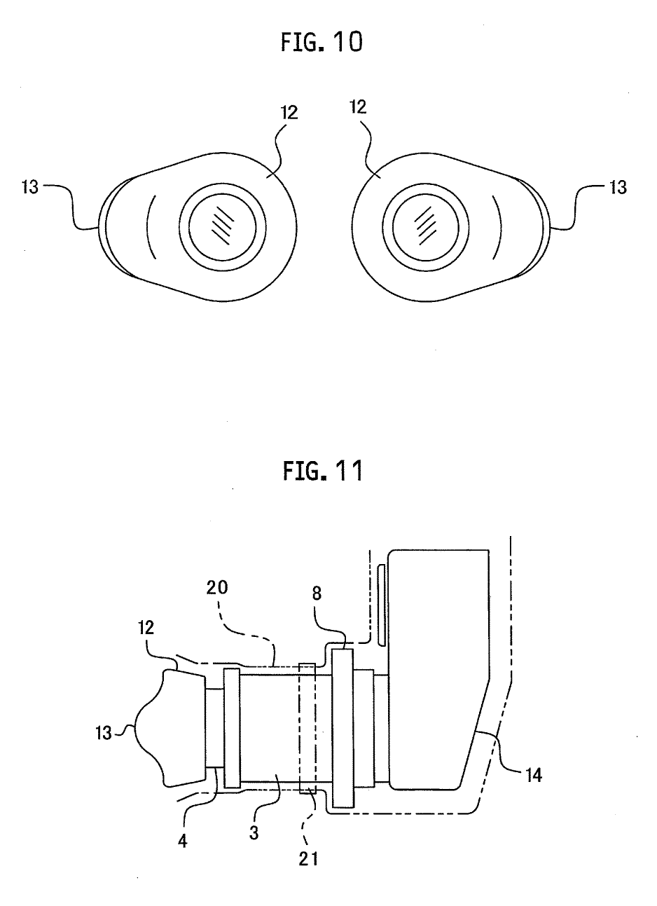

An embodiment of the present invention will be explained with reference to FIGS. 1 to 11.

A surgical microscope 1 has a light port 11 to which an eyepiece optical unit 2 is attached. The eyepiece optical unit 2 has two eyepieces 3 each employing an eyepiece structure according to the embodiment of the present invention. The eyepiece 3 includes an inner barrel 4, an intermediate barrel 5, and outer barrels 6 and 7. The outer barrels 6 and 7 collectively serve as an outer barrel. A base end of the intermediate barrel 5 is provided with a large-diameter flange 8 that protrudes outside a surface of the outer barrel 6.

The inner barrel 4 incorporates a vision correction lens 9 for adjusting diopter scale. In front of the vision correction lens 9, an astigmatic lens 10 is added. To a front end of the inner barrel 4, a rubber 12 is attached to prevent external light from entering into the eyepiece 3. The rubber 12 is integrally provided with a side projection 13 protruding rightward (or leftward) to prevent external light from laterally entering into the eyepiece 3.

The eyepiece optical unit 2 has a linking part 14 that incorporates a prism 15. A left-and-right pair of beams L emanating from the light port 11 are guided through the prism 15 and eyepieces 3 to the eyes of a surgeon.

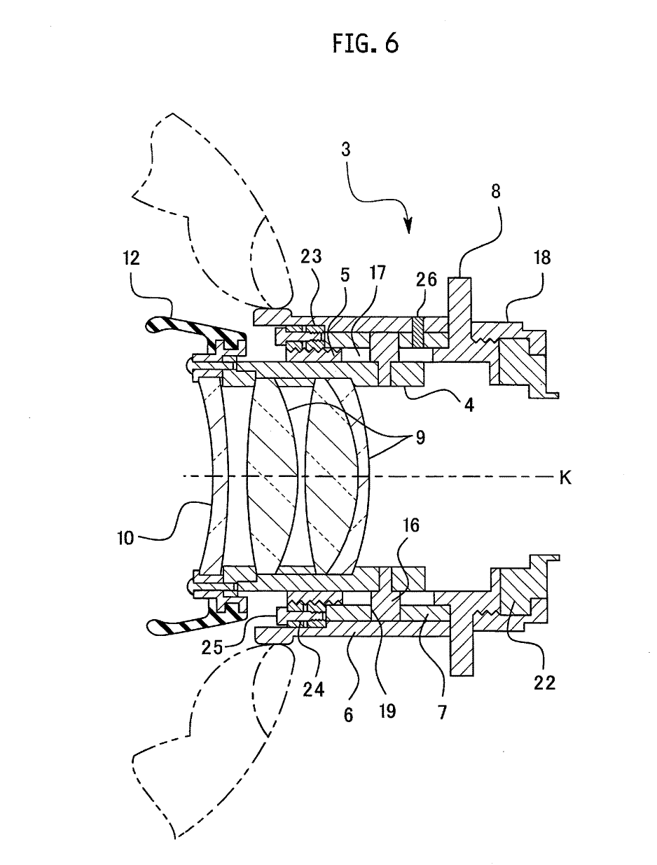

An outer face of the inner barrel 4 is provided with a protrusion 16. The intermediate barrel 5 has a straight hole 17 that is foamed along an optical axis K (FIG. 6). The intermediate barrel 5 is fixed through collars 18 and 22 to the linking part 14 so that the intermediate barrel 5 may not rotate. On an internal part of the outer barrels 6 and 7, a spiral groove 19 is formed. The protrusion 16 of the inner barrel 4 engages through the straight hole 17 of the intermediate barrel 5 with the spiral groove 19 of the outer barrel 7. A stopper ring 23 is set over the intermediate barrel 5 and is screwed to a thread of the intermediate barrel 5. The stopper ring 23 has a slit 24 that is narrowed with a screw 25 to fix the stopper ring 23 to the thread of the intermediate barrel 5, thereby preventing the outer barrel 7 from slipping out. To the outer barrel 7, the outer barrel 6 is fixed with a pin 26, thereby preventing the outer barrel 6 from slipping out.

To adjust diopter scale, the inner barrel 4 is moved back and forth by manually rotating the outer barrel 6. Rotating the outer barrel 6 causes the spiral groove 19 to rotate relative to the protrusion 16 and push the protrusion 16 back and forth, thereby linearly moving the inner barrel 4 back and forth along the optical axis K. At this time, the protrusion 16 is guided in the straight hole 17 of the nonrotatable intermediate barrel 5, and therefore, the inner barrel 4 moves back and forth without rotating.

This configuration maintains directivity of the astigmatic lens 10 to sufficiently demonstrate an astigmatism preventive function for a surgeon who suffers from astigmatism and conducts a surgical operation with the surgical microscope 1. The surgeon is able to efficiently conduct the surgical operation without glasses.

The inner barrel 4 does not rotate, and therefore, the side projection 13 formed on the rubber 12 at the front end of the inner barrel 4 does not rotate, thereby surely preventing external light from laterally entering into the eyepiece 3.

The base end of the intermediate barrel 5 is provided with the flange 8 whose diameter is larger than that of the surface of the outer barrel 6. Accordingly, when the eyepiece 3 is covered with a sterilized drape 20, a tightening tape 21 of the drape 20 catches the flange 8 to prevent the drape 20 from shifting toward the base end of the eyepiece 3 and exposing the eyepiece 3.

Modifications of the present invention will be explained.

Instead of the two outer barrels 6 and 7, a single outer barrel is adoptable.

A lens to be added to the vision correction lens 9 is not limited to the astigmatic lens 10. Any other correction lens having directivity in rotation directions may be added thereto.

According to the first aspect of the present invention, rotating the outer barrel causes the protrusion of the inner barrel to be guided along the spiral groove of the inner face of the outer barrel and moved back and forth along the optical axis of the eyepiece. At this time, the protrusion of the inner barrel is guided through the straight hole of the intermediate barrel that is not rotatable. Accordingly, the inner barrel linearly moves along the optical axis of the eyepiece without rotating around the optical axis.

A second aspect of the present invention adds the astigmatic lens to the inner barrel so that a surgeon suffering from astigmatism is able to conduct a surgical operation without glasses. The astigmatic lens does not rotate because the inner barrel is nonrotatable, and therefore, maintains its astigmatism correcting function.

A third aspect of the present invention provides the rubber at an end of the inner barrel with the side projection. The side projection maintains a specified orientation when the inner barrel, which is nonrotatable, is moved back and forth to adjust diopter scale, thereby surely preventing external light from laterally entering into the eyepiece.

A fourth aspect of the present invention provides a base end of the intermediate barrel with the flange whose diameter is larger than the surface of the outer barrel. The flange catches a sealing part of a drape that covers the eyepiece, thereby preventing the drape from shifting toward a base end of the eyepiece and exposing the eyepiece.

This patent application claims the benefit of priority under 35 U.S.C. 119(a) to Japanese Patent Application No. 2016-078646 filed on Apr. 11, 2016 whose disclosed contents are cited herein.

What is claimed is:

1. An eyepiece structure for a surgical microscope having an inner barrel that incorporates a vision correction lens, and a rotatable outer barrel, comprising:
an intermediate barrel interposed between the outer barrel and the inner barrel and being not rotatable, and the intermediate barrel having a straight hole;
a spiral groove formed on an inner face of the outer barrel; and
a protrusion formed on an outer face of the inner barrel and engaged through the straight hole with the spiral groove.

2. The eyepiece structure of claim 1, further comprising an astigmatic lens added to the inner barrel.

3. The eyepiece structure of claim 1, further comprising
a rubber arranged at an end of the inner barrel and having a side projection outwardly protruding in one of left and right directions.

4. The eyepiece structure of claim 1, further comprising a flange formed at a base end of the intermediate barrel and having a diameter larger than that of a surface of the outer barrel.
